(19) United States
(12) Patent Application Publication
(10) Pub. No.: US 2026/0100576 A1
(43) Pub. Date: Apr. 9, 2026

(54) ENERGY PRODUCTION PLANT WITH POWER CONVERTER UNIT

(71) Applicant: SMA Solar Technology AG, Niestetal (DE)

(72) Inventor: Andreas Falk, Kassel (DE)

(21) Appl. No.: 19/405,895

(22) Filed: Dec. 2, 2025

Related U.S. Application Data
(63) Continuation of application No. PCT/EP2024/066608, filed on Jun. 14, 2024.

(30) Foreign Application Priority Data
Jun. 16, 2023 (DE) 10 2023 115 773.6

(51) Int. Cl. H02H 7/20; H02H 1/00

(52) U.S. Cl. CPC H02H 7/20; H02H 1/0007

(57) ABSTRACT

An energy production plant with a power converter circuit for connection to a PV generator is disclosed. The PV generator includes a plurality of PV main strings connected in parallel and are each connected to the power converter circuit via two DC input lines on an input side thereof via a DC link circuit. A monitoring circuit including a differential current measuring sensor/circuit, an isolating circuit/switch and a controller is assigned to each pair of DC input lines. The controller of the monitoring circuit is configured to switch the isolating circuit/switch and isolate the PV main string after a fault has been identified when a differential current threshold is exceeded. At least a defined discharge capacitance to earth is arranged as a feedback path for an earth current measurement by the differential current measuring sensor/circuit at least one pole of the DC link circuit.

### REFERENCE TO RELATED APPLICATIONS

This application is a Continuation of International Application number PCT/EP2024/066608, filed on Jun. 14, 2024, which claims the benefit of German Application number 10 2023 115 773.6, filed on Jun. 16, 2023. The contents of the above-referenced patent applications are hereby incorporated by reference in their entirety.

### FIELD

The disclosure relates to energy production plants with a power converter circuit that, in a first aspect, comprises a DC/AC converter that can not only feed energy into an alternating voltage grid (AC grid) but also extract energy from the AC grid. Furthermore, the disclosure can also relate to a DC-DC converter. In a first embodiment of the disclosure, a DC-side energy source is a photovoltaic energy production plant (PV plant); in another embodiment, it is a battery-electric storage system (BESS).

### BACKGROUND

PV energy production plants are opening up an ever wider range of application possibilities in the context of large-scale plants. In addition to private, home-based energy production, i.e. the conversion of DC voltage provided by PV generators into AC grid voltage by means of an inverter and supplying a household grid or feeding into a public grid, PV power plants in increasingly larger power classes as large-scale power plants are assuming a significant share of the public electricity supply. There are also other applications as part of the general transition of industrial processes to more ecologically sustainable methods. In this way, large PV energy production plants, without converting and providing AC power, can be used as a DC source to power industrial facilities such as battery parks, factories, electrolyzers or seawater desalination plants and to provide a direct current grid.

A PV plant can comprise a large number of electrical components, in particular PV modules, which are distributed in a decentralized manner over a large area. A group of PV modules grouped as a string, i.e. in the form of a series circuit, is also called a PV string. A PV generator of a PV plant can comprise one or more PV sub-generators or main strings, which consist of a plurality of PV strings that are connected in parallel to one another by means of a connecting device, also called a combiner box, if applicable in each case via a separate DC/DC converter, to a common direct current link circuit (DC link circuit) of a PV inverter or, depending on the application, to another power converter unit, such as a DC/DC converter. Each of the PV sub-generators can comprise one or more PV strings connected in parallel to one another. Due to their design, the PV modules of a PV plant always have an electrical capacitance with respect to their surroundings, in particular with respect to their usually earthed mounting system. This capacitance is not absolutely necessary for the function of the PV plant but does inevitably result from the mechanical design of the PV modules. It is for this reason often referred to as “parasitic capacitance” or “discharge capacitance.” The parasitic capacitance of the PV plant usually increases with the size of the PV generator assigned thereto, which is why a powerful PV generator also has a correspondingly large parasitic capacitance. In addition, the parasitic capacitance is dependent on ambient conditions and, for example, increases further during rain due to an associated moist surface of the PV modules and/or due to a dielectric constant of the air that changed on account of increased humidity.

Due to the parasitic capacitance of the PV modules with respect to the earth potential, normal operation of the PV plant always results in a more or less strong discharge current from the PV generator toward the earth potential.

If, due to a fault, e.g. a defective line isolation, an earthed person now comes into contact with a live component of the PV generator, e.g. the defective line, an additional fault current toward the earth potential will result, usually abruptly, due to the direct contact. Since a fault current starting at a value of approximately 30 mA can endanger personal safety and starting at a value of approximately 300 mA becomes relevant to fire protection, it is generally required to identify such a fault current reliably and to initiate further measures, for example, a shutdown and/or short-circuiting of the PV generator, in particular of the relevant PV sub-generator, when such a fault current is detected. As a rule, two criteria must be met. On the one hand, the fault current must not have any jumps, i.e. no rapid increases above a comparatively low limit value of, for example, 30 mA, in order to ensure maximum personal protection. On the other hand, for reasons of fire protection and system protection, a total differential current, or capacitive discharge current, occurring overall and measured via the connection lines of a PV generator, must not exceed a significantly higher limit value of several hundred mA.

Due to the ever increasing nominal outputs of PV plants, the parasitic capacitances of the assigned PV generators or PV sub-generators are also rising and thus also the capacitive discharge currents always present in normal operation of the PV plant. However, the threshold value of, for example, 300 mA assigned to the discharge current remains constant but can still if necessary be reduced due to stricter normative constraints. For this reason, any fault current that may be present can be significantly smaller compared to the always present capacitive discharge current of the PV plant. The detection of the fault current is therefore becoming increasingly complex and expensive due to the low signal-to-noise ratio and the associated measuring systems that require a sensitive design. It is therefore desirable, in particular also in the case of larger PV plants, to be able to detect a potentially occurring fault current reliably and nevertheless cost-effectively, in particular if the potentially occurring fault current is small compared to the capacitive discharge current always present in normal operation of the PV plant.

With regard to earth faults, normative requirements, such as IEC 63112, stipulate that PV energy production plants above a certain power class must either be operated behind a fence in an electrical operating area or, if they are publicly accessible, must be equipped with a so-called RCD (“residual current detection”) that meets the aforementioned criteria.

The problem is that the parasitic capacitance of a PV field connected to a central DC link circuit of a power converter unit, such as a central inverter, is so large that if, due to an isolation fault, a person or animal touches a pole of the PV field, they can be damaged by the large release current that occurs when the entire capacitance is transferred via their body.

In the case of particularly large PV fields, a parallel connection is effected by interconnecting individual PV generators to form PV strings, which are in turn combined in connecting units to form sub-generators or “main strings,” and the currents from a plurality of these connecting units are then combined in a DC collection unit, such as a DC busbar or a common DC link circuit, before being fed to a power converter unit, such as an inverter or a DC/DC converter. RCDs, which carry out fault monitoring and preferably also comprise a fault isolating device, are preferably arranged in the connecting units in order to be able to monitor a sub-generator on a targeted basis and isolate it if necessary. The earth fault monitoring in the RCDs is usually carried out via a differential current measurement of the DC and DC+ supply lines of the individual PV sub-generators. So that an RCD can be used, the unwanted earth current must be able to flow at least partially past the RCD. This can only happen if there is an earth connection on the side of the RCD facing away from the fault, in particular if the PV field, or more precisely the DC link circuit, is earthed, i.e. not floating or not isolated.

However, for many applications, an isolated structure of the DC busbar or of the DC link circuit of the power converter unit is a basic requirement, for example in the case of DC coupling with batteries in parallel with the PV voltage.

For many such applications, it is therefore not possible at the present time to implement a design with a central DC link circuit or with a central power converter unit, without a fenced safety protection area and only with RCD monitoring.

For particularly large PV plants, there is therefore increased difficulty in extracting a fault current in order to monitor it for compliance with a low limit value and short-term rises.

### SUMMARY

The disclosure is directed to providing a PV energy production plant that provides improved fault current monitoring even with a high electrical power and correspondingly large capacitance of connected PV generators.

The energy production plant according to the disclosure comprises a power converter circuit configured to connect to a PV generator. The PV generator comprises a plurality of PV main strings which are connected together in parallel and are each connected to the power converter circuit of the energy production plant via two DC input lines on an input side thereof. In one embodiment, the DC link circuit of the power converter unit is electrically isolated. The disclosure further comprises a monitoring circuit comprising a differential current measuring sensor or circuit, an isolating switch or circuit, and a controller circuit. The monitoring circuit is assigned to each pair of DC input lines assigned to a PV main string, wherein the controller circuit of the monitoring circuit is configured to switch the isolating switch or circuit and isolate the PV main string after a fault has been identified by virtue of a differential current threshold value being exceeded. In such instance, at least a defined discharge capacitance to earth is arranged as a feedback path for an earth current measurement of the differential current measuring sensor or circuit at at least one pole of the DC link circuit.

In this way, it is made possible for a monitoring circuit to trip via the feedback path defined by the defined discharge capacitance, such that an unwanted fault current can be detected by the differential current measuring sensor or circuit. The discharge capacitances are defined and dimensioned in such a way that the isolated (or floating) structure of the plant is ensured and a naturally occurring discharge current occurring via the parasitic capacitances of the individual sub-generators can be distinguished from an unwanted fault current. The differential current measuring sensors or circuits assigned to the sub-generators can thus detect a difference between an input current into a sub-generator and a return current that would otherwise flow to earth via a fault location on the affected sub-generator. The monitoring circuit described, which comprises a differential current measuring sensor or circuit, an isolating switch or circuit and a controller circuit, is also called an RCD (“residual current detection and interruption”). The term RCD is also used synonymously for the monitoring circuit assembly.

The parasitic capacitances of the non-faulty sub-generators are usually not sufficiently large for a recharging current to flow via these parasitic capacitances and to persist long enough for the RCD in the fault path to be tripped before all capacitances have assumed a new steady-state voltage relative to earth.

In addition, in one embodiment the parasitic capacitance is not clearly defined but depends on the ambient conditions, contamination and the general condition of the PV modules. In new, dry PV modules, these parasitic capacitances are so small that the required tripping of an RCD of a faulty sub-generator would not be successful. By a sufficiently large dimensioning the discharge capacitances on the side of the RCD facing away from the fault, a recharging current can flow via the defined discharge capacitances and persist until all capacitances involved have assumed a new steady-state voltage relative to earth. This is enough to trip the RCD in the fault path.

The isolation by means of the isolating switch or circuit of the monitoring circuit after fault identification by the differential current measuring sensor or circuit is, in one embodiment, only triggered after a defined differential current threshold value has been exceeded. This makes it possible, on the one hand, to comply with regulatory requirements regarding a permissible fault current, for example, in terms of its absolute value or the dynamics of a rapid change, and, on the other hand, to prevent tripping from already occurring in the case of small currents introduced via the parasitic capacitances of the non-faulty sub-generators.

An energy production plant according to the disclosure is, in one embodiment, formed by a photovoltaic (PV) energy production plant that has a plurality of PV main strings which are connected together in parallel. These are connected via DC input lines to a DC link circuit, for example, a DC bus line or busbar of the power converter circuit. Within the scope of the disclosure, input lines together with a busbar can also be considered as part of the DC link circuit in one embodiment. The power converter circuit can be implemented differently depending on the application. In this way, the power converter circuit can be formed by a DC/AC central inverter, which is configured to convert the energy supplied from the DC energy source, such as the PV generators, and feed it into an alternating voltage grid (AC grid) and/or also to draw energy from the AC grid. In one embodiment the inverter can be single-stage or multi-stage; for example, it can comprise additional DC/AC or DC/DC converter stages. In order to provide a feedback path, in one embodiment the defined discharge capacitances are arranged on the DC side between the power converter and the monitoring circuits of the sub-generators on the DC link circuit. In one embodiment, at least one discharge capacitor is present at at least one pole of the DC link circuit, so that the effect according to the disclosure can occur.

Advantageous embodiments of the disclosure are specified in the following description and the dependent claims, the features of which can be applied individually and in any desired combination with one another.

In one embodiment of the device according to the disclosure, more than one discharge capacitor is arranged at at least one pole of the DC link circuit. This leads to improved fault tolerance and redundancy.

In another embodiment of the device according to the disclosure, the at least one discharge capacitor is arranged exclusively or additionally at one or more intermediate potentials of the DC link circuit. For example, a discharge capacitor can be arranged at a midpoint of the link circuit. This is particularly advantageous for power converter circuits with symmetrical topologies.

In another embodiment of the device according to the disclosure, the discharge capacitors are additionally connected to damping resistors connected in series. These advantageously ensure that recharging currents can flow over a sufficiently long period of time, such that the tripping time of the RCD is not undershot in the event of a hazardous fault current, and in one embodiment it is advantageous for the damping resistances to range between 10Ω and 2.5 kΩ. In this way, the defined discharge capacitances can be adapted more precisely to the conditions of the plant. In addition, this avoids disruptive interactions with any EMC suppression capacitors that may also be present.

In another embodiment, the defined discharge capacitances are dimensioned significantly smaller than the maximum total capacitance of the PV generator to earth, for example, less than 10%, or less than 3% of the total capacitance of the PV generator to earth. In one embodiment, the discharge capacitances are dimensioned significantly smaller in relation to the maximum total capacitance of the PV generator to earth at the most unfavorable operating point of the PV generator. In this way, the discharge capacitances only increase the total capacitance of the plant very slightly and therefore have only a negligible influence on the efficiency of the PV plant.

In another embodiment of the device according to the disclosure, the differential current threshold value of the monitoring circuit is less than or equal to 300 mA and, in addition, sudden changes in the range of 30 to 150 mA are monitored. A value of 300 mA as the limit value for the fault current in one embodiment meets common normative fire protection requirements, such as those required for photovoltaic plants in the agricultural sector. Sudden changes in the range of 30 to 150 mA are monitored, in one embodiment, according to IEC 62109-2. In this way, safe operation of the plant is made possible for applications that were previously not accessible to isolated PV energy production plants.

In another embodiment of the device, the DC link circuit comprises a DC isolating switch, wherein the discharge capacitors are arranged on the side of the DC isolating switch facing the PV input side of the power converter circuit. In many large plants, it is provided or even required that the power converter circuit has a DC isolating switch or switch, which isolates the link circuit or the supply line of the power converter circuit from the entirety of the PV generators; for example, for diagnostic or maintenance purposes, or in plants in which a plurality of components are connected in parallel to the same link circuit. So that seamless monitoring for fault locations is possible, a discharge capacitor is in one embodiment arranged between the PV input side and the DC isolating switch. In this way, monitoring can continue even when the DC isolating switch is open, for example, in cases where the PV modules are still carrying voltage.

In one embodiment of the device according to the disclosure, the power converter circuit is formed by a central inverter circuit or unit, which, on the output side thereof, is connected to an alternating voltage grid for supplying electrical power via an AC isolating switch, a transformer and a grid connection device. In this application, the PV energy production plant is designed to feed energy into an alternating voltage grid.

In a further design embodiment of the device, an electrically isolated battery-electrical storage system (BESS) is additionally provided, which is connected to the DC link circuit on the side facing away from the DC isolating switch or circuit. The DC input lines that are assigned to the battery-electric storage system, or to sub-batteries of the storage system, are assigned to a further monitoring circuit comprising a differential current measuring sensor or circuit, an isolating switch or circuit and a controller circuit, wherein the controller circuit of the monitoring circuit is configured, after a fault has been identified by virtue of a differential current threshold value being exceeded, to isolate the isolating switch or circuit and isolate the battery-electric storage system, wherein additional discharge capacitors are optionally arranged on the side of the DC link circuit facing away from the DC isolating switch or circuit. The differential current measuring sensor or circuit can consist of a large number p of individual differential current measuring sensors or circuits, each of which is assigned to a sub-battery, for example, a battery rack. Accordingly, up to p isolating switches or circuits and controller circuits must be provided. Corresponding battery-electric storage systems are structured in one embodiment to be electrically isolated, which also gives rise to the same problem of discharge current monitoring. In this way, the power produced by the PV generator can be used to charge the sub-batteries of the BESS. Alternatively or additionally, in the event that the PV generator has been isolated from the power converter circuit by the DC isolating switch or circuit, electrical energy can be provided exclusively via the BESS.

In one embodiment the discharge capacitors of the battery-electric storage system are also connected to damping resistors connected in series.

In one embodiment, the monitoring circuits are arranged on DC input lines that are arranged within a housing of the power converter circuit and are thus part of the power converter circuit.

In one embodiment, the monitoring circuits are arranged on DC input lines that are part of a connecting device assigned to each main string, and that connect a plurality of PV strings to form a main string, wherein the connecting device (also referred to as a combiner box) is arranged outside a housing of the power converter circuit. This decentralized arrangement is advantageous in one embodiment for large plants with a large number of main strings, or for a simplified expansion of the plant or interchangeability of the individual components.

In another embodiment of the device according to the disclosure, a plurality of monitoring circuits are provided and each individual PV string of the PV main string is assigned a monitoring circuit. In this way, a more fine-grained monitoring can advantageously be provided, since in the event of a fault not the entire sub-generator is isolated, but only individual strings of the sub-generator, while the non-faulty strings remain available.

In one embodiment the device according to the disclosure, failure monitoring of the discharge capacitors can be carried out by an impedance measurement or a voltage measurement. If a plurality of discharge capacitors are arranged on a DC link circuit, for example one on a positive pole, one on a negative pole and others at intermediate potentials, the design can be such that if one discharge capacitor fails, its function is compensated for by the other discharge capacitors.

In a further aspect of the disclosure, the energy production plant is designed without a PV generator and only a battery-electric storage system is available as a direct current source.

The overall system comprising a battery-electric storage system and a power converter circuit comprises a plurality of sub-batteries connected in parallel, which are connected to a DC link circuit of the power converter circuit, wherein the DC link circuit of the power converter circuit is electrically isolated. Each sub-battery is assigned a monitoring circuit comprising a differential current measuring sensor or circuit, an isolating switch or circuit and a controller circuit. The controller circuit of the monitoring circuit is configured to switch the isolating switch or circuit and isolate the sub-battery after a fault has been identified by virtue of a differential current threshold value being exceeded, wherein at least a defined discharge capacitance to earth is arranged at at least one pole of the DC link circuit as a feedback path for an earth current measurement of the differential current measuring sensor or circuit. The functionality and further embodiments of the individual components correspond to those of the design with a PV generator, such that at this point reference is made to the corresponding previous explanations in this regard.

Advantageous developments of the disclosure result from the claims, the description and the drawings. The advantages of features and combinations of several features mentioned in the description are merely examples and may take effect alternatively or cumulatively without the advantages necessarily being achieved by embodiments according to the disclosure. Without altering the subject-matter of the appended claims, the following applies with regard to the disclosure content of the original application documents and the patent: further features can be found in the drawings—in particular the relative arrangement and operative connection of a plurality of components. The combination of features of different embodiments of the disclosure or of features of different claims is also possible in deviation from the selected back-references in the claims and is hereby encouraged. This also applies to features that are shown in separate drawings or are mentioned in the description thereof. These features can also be combined with features of different claims. Likewise, features listed in the claims may be omitted for further embodiments of the disclosure.

The features mentioned in the claims and the description are to be understood with respect to their number in such a way that exactly this number or a larger number than the number mentioned is present, without requiring an explicit use of the adverb “at least.” So, for example, when an element is mentioned, this is to be understood as meaning that exactly one element, two elements or more elements are present. These features can be supplemented by other features or can be the only features of which the product in question consists.

The reference signs contained in the claims do not constitute a limitation of the scope of the subject-matter protected by the claims. They merely serve the purpose of making the claims easier to understand.

### BRIEF DESCRIPTION OF THE FIGURES

The disclosure is illustrated below with the aid of figures. In the figures:

FIG. 1 shows an embodiment of a device according to the disclosure;

FIG. 2 shows a further embodiment of a device according to the disclosure with a battery-electric system.

### DETAILED DESCRIPTION

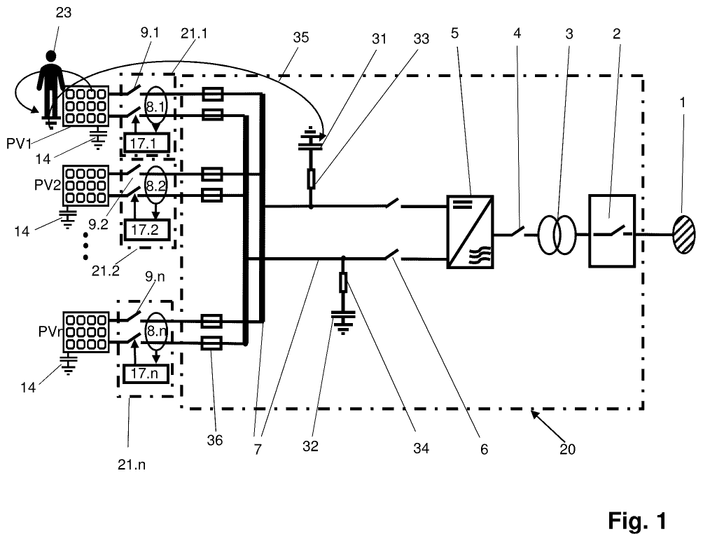

FIG. 1 shows an embodiment of a PV power generation plant according to the disclosure. The PV energy production plant comprises, as an embodiment of a direct current generator, a photovoltaic generator formed by a plurality of PV main strings PV1, PV2 . . . . PVn. Each PV main string PV1 to PVn comprises a plurality of PV modules connected in series or a plurality of PV strings that in turn comprise a plurality of PV modules. The PV main strings PV1 to PVn are designed similarly in one embodiment, in one example, identically, with regard to the number and type of PV modules. In addition, the PV main strings PVn are arranged close enough together that they are subject to at least similar ambient conditions with regard to irradiation and temperature. By way of example, a power converter unit, system or circuit 20 is designed as a so-called multi-string inverter. For this purpose, it comprises at least as many DC inputs for DC lines as there are PV main strings, PVn, in the plant. In one embodiment the DC inputs are protected by pairs of fuses 36. The individual PV main strings PVn are connected in parallel to a common DC link circuit 7, for example, via DC busbars. This DC link circuit 7 can, for example, also be formed by a split midpoint link circuit. The common DC link circuit 7 is in turn connected to a DC side of a DC/AC converter 5 of the power converter unit 20. In one embodiment, a DC isolating switch 6 is also provided, which can isolate the entire PV generator from the DC/AC converter 5 if necessary. By way of example, the AC side of the DC/AC converter 5, which in FIG. 1 is configured as a three-phase converter, is connected to a likewise three-phase alternating-voltage (AC) grid 1, for example, a medium-voltage grid, via an AC isolating switch 4, a transformer 3, for example, a medium-voltage transformer, and a grid connection device, switch or circuit 2. By way of example, a single-stage DC/AC converter 5 is shown. Within the scope of the disclosure, this can also be designed as a multi-stage converter, for example, with additional DC/DC stages not only unidirectional but also bidirectional. A controller system or circuit (not shown) of the power converter unit 20 controls the switches of the DC/AC converter 5 for the desired voltage conversion. Further components such as EMC filters and line filters are not shown for the sake of clarity. In one embodiment, the PV plant, for example, the DC link circuit 7, is isolated, or floating, without a fixed potential to earth and is galvanically isolated from the AC grid 1 via the transformer 3.

For monitoring the power converter unit 20 for the occurrence of critical fault currents, which indicate earth faults in the region of the PV strings and their parallel connection, a plurality of monitoring circuits or units 21.1 to 21.n are provided, so-called RCDs (residual current detection and interruption devices). These each comprise, in one embodiment, a differential current measuring circuit or sensor or device 8.1 to 8.n, an isolating switch or circuit 9.1 to 9.n and a controller circuit 17.1 to 17.n. These are in each case, in one embodiment, assigned to the PV main strings PV1 to PVn. With the differential current measuring devices 8.1 to 8.n, the differential current across a pair of input lines of a PV main string PV1 to PVn is captured or measured in each case. The monitoring circuits or units 21.1 to 21.n can be formed as part of the power converter circuit or unit 20, for example, within a container housing of the power converter unit 20, or externally, for example, in a connecting unit or combiner box in which individual PV modules or PV strings are interconnected to form a PV main string PVn and in which further monitoring and protection components can also be arranged.

The individual PV main strings PV1 to PVn have a parasitic capacitance 14 in relation to the earth potential, which can be different in each case. Discharge currents may flow in the direction of earth potential via the parasitic capacitances 14. These are capacitive reactive currents. The discharge currents, together with the parasitic capacitances 14, are dependent on the ambient conditions of the PV strings such as humidity, temperature, precipitation, or the like. In some cases, they can change significantly over time, even if rather slowly over time. However, they change in a similar manner for the similar PV main strings PV1 to PVn.

In the event of a fault, for example, if an earthed person 23 makes a contact between one of the PV modules, shown in FIG. 1 by way of example for PV main string PV1, and the earth potential, a fault current will flow toward the earth potential in addition to the discharge current on the PV string in which the fault was caused.

For the protection of persons 23 against electric shock, it must now be possible to detect sudden changes in current, such as those caused by the flow of life-threatening currents through the human body of persons 23. Such fault currents are already life-threatening at current levels that can be significantly below the typical current levels of non-hazardous capacitive discharge currents.

In one embodiment, such monitoring is reliably determined via the differential current measuring devices 8.1 to 8.n when a current difference occurs on the two monitored lines of a PV main string. This is shown in FIG. 1 using the example of the PV main string PV1. In order to be able to identify the currents flowing via the discharge capacitors 14 and, in the event of a fault, via the earthed person 23, a feedback path is required, which, however, is not present in an isolated structure of the DC link circuit 7. For this reason, defined discharge capacitors 31, 32 are provided, through which a feedback path 35 is provided. These are present at at least one pole of the link circuit 7, for example, at the positive pole, the negative pole or at a possible midpoint, if available. In this case, in order to increase safety, defined discharge capacitors 31, 32 can also be provided at a plurality of points, here not only at the positive but also at the negative pole, as shown in FIG. 1. The discharge capacitors are arranged on the side of the DC isolating switch 6 facing the PV generator. This also makes monitoring possible when the DC isolating switch 6 is open.

In this way a defined feedback path 35 provided for an isolated or floating structure, which does not depend on ambient conditions, as in the case of the parasitic capacitances 14. By means of the differential current measuring device 8.1, a sudden change in the usual discharge currents and/or a specified limit value being exceeded can now be detected. This signal is sent to the controller circuit 17.1, which then trips the isolating switch or circuit 9.1 and isolates the faulty PV main string PV1.

In one embodiment, the differential current threshold value of the monitoring circuit or unit 21.1 is less than or equal to 300 mA and, in addition, sudden changes in the range of 30 to 150 mA are monitored. In one embodiment the defined discharge capacitors 31, 32 are dimensioned significantly smaller than the maximum total capacitance of the PV generator to earth, for example, less than 10%, or less than 3% of the total capacitance of the PV generator to earth. In this way, the discharge capacitors increase the total capacitance of the plant very slightly and therefore have a negligible influence on the efficiency of the PV plant.

In addition, in one embodiment the defined discharge capacitors are connected to damping resistors 33, 34 connected in series, so that recharging currents can flow over a sufficiently long time such that the tripping time of the RCD is undershot in the event of a dangerous fault current occurring. These are, for example, between 10Ω and 2.5 kΩ.

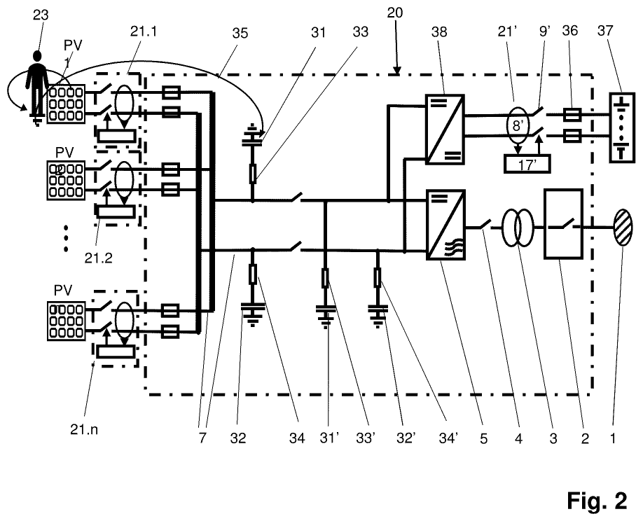

In FIG. 2, a further embodiment of a PV energy production plant according to the disclosure is shown, which substantially corresponds to the embodiment shown in FIG. 1. For reasons of clarity, not all details of the embodiment are explained and provided with reference numerals, since these have already been described in the embodiment shown in FIG. 1 and are clearly identifiable as identical or similar thereto. In addition to the embodiment shown in FIG. 1, an electrically isolated battery-electrical storage system (BESS) 37 is provided, which is connected between the DC isolating switch 6 and the DC/AC converter 5 to the DC link circuit 7 via a DC/DC converter 38. A further monitoring circuit or unit 21′ with a differential current measuring device 8′, an isolating switch 9′ and a controller 17′ is assigned to the DC input lines assigned to the battery-electric storage system 37 or to sub-batteries of the storage system 37. The controller circuit 17′ of the monitoring circuit or unit 21′ is configured, in an analogous manner to the monitoring circuits or units 21.1 to 21.n of the PV generator, after a fault has been identified by virtue of a differential current threshold value being exceeded, to switch the isolating switch or circuit 9′ and to isolate the battery-electrical storage system 37, wherein further defined discharge capacitors 31′, 32′ along with damping resistors 33′, 34′ are arranged on the side of the DC link circuit 7 facing away from the DC isolating switch 6. The differential current measuring circuit or sensor or device 8′ can comprise a large number p of individual differential current measuring devices 8′, each of which is assigned to a sub-battery, for example, a battery rack. Accordingly, up to p isolating switches 9′ and controllers 17′ must be provided. Corresponding battery-electric storage systems are likewise usually electrically isolated, which also gives rise to the same problem of discharge current monitoring. In this way, the power produced by the PV generator can be used to charge the sub-batteries of the BESS. Alternatively or additionally, in the event that the PV generator is isolated from the power converter circuit or unit 20 by the DC isolating switch or circuit 6, electrical energy is provided exclusively via the BESS 37.

What is claimed is:

1. An energy production plant with a power converter circuit configured to connect to a PV generator, wherein the PV generator comprises a plurality of PV main strings connected in parallel and each connected to the power converter circuit of the PV energy production plant via two DC input lines on an input side of the power converter circuit via a DC link circuit, wherein the DC link circuit of the power converter circuit is electrically isolated, the energy production plant further comprising a monitoring circuit comprising a differential current measuring sensor or circuit, an isolating circuit or switch and a controller circuit assigned to each pair of DC input lines assigned to a PV main string, wherein the controller circuit of the monitoring circuit is configured to switch the isolating circuit or switch and to isolate the PV main string after a fault has been identified by virtue of a differential current threshold value being exceeded, wherein at least one discharge capacitance to earth is arranged as a feedback path for an earth current measurement by the differential current measuring device, at at least one pole of the DC link circuit.

2. The device according to claim 1, wherein the at least one discharge capacitance comprises more than one discharge capacitor arranged at at least one pole of the DC link circuit.

3. The device according to claim 1, wherein the at least one discharge capacitance is arranged exclusively or additionally at one or more intermediate potentials of the DC link circuit.

4. The device according to claim 2, wherein each of the more than one discharge capacitors are additionally connected to respective damping resistors connected in series.

5. The device according to claim 4, wherein the damping resistors have resistance values that are between 10Ω and 2.5 kΩ.

6. The device according to claim 1, wherein the at least one discharge capacitance is less than a maximum total capacitance of the PV generator to earth.

7. The device according to claim 1, wherein the differential current threshold value of the monitoring circuit is less than or equal to 300 mA and wherein the monitoring circuit is configured to capture changes in differential current in the range of 30 to 150 mA.

8. The device according to claim 1, wherein the DC link circuit comprises a DC isolating circuit or switch, and wherein the at least one discharge capacitance is arranged on a side of the DC isolating circuit or switch facing a PV input side of the power converter circuit.

9. The device according to claim 1, wherein the power converter circuit comprises an inverter circuit, which, on an output side thereof, is configured to connect to an alternating voltage grid for supplying electrical power via an AC isolating circuit or switch, a transformer and a grid connection circuit.

10. The device according to claim 9, further comprising an electrically isolated battery-electrical storage system connected to the DC link circuit via a DC/DC converter circuit on a side facing away from the DC isolating circuit or switch, and comprising at least one further monitoring circuit, comprising a differential current measuring sensor or circuit, an isolating circuit or switch, and a controller circuit assigned to DC input lines assigned to the battery-electrical storage system or to sub-batteries of the battery-electrical storage system, wherein the controller circuit of the further monitoring circuit is configured to switch the isolating circuit or switch and to isolate the battery-electrical storage system after a fault has been identified by virtue of a differential current threshold value being exceeded, wherein further discharge capacitors are arranged on the DC link circuit.

11. The device according to claim 10, wherein the further discharge capacitors of the battery-electric storage system are additionally connected to respective damping resistors connected in series.

12. The device according to claim 1, wherein the monitoring circuit and the further monitoring circuit are arranged on DC input lines that are arranged within a housing of the power converter circuit and are part of the power converter circuit.

13. The device according to claim 1, wherein each of the monitoring circuits are part of a connecting device that is assigned to each PV main string and the connecting device is configured to connect a plurality of PV strings to form a PV main string, wherein the connecting device is arranged outside a housing of the power converter circuit.

14. The device according to claim 13, wherein each individual PV string of the PV main string is assigned a corresponding monitoring circuit.

15. The device according to claim 1, further comprising a measurement circuit configured to monitor for failure of the discharge capacitors via an impedance measurement or a voltage measurement.

16. A battery-electric storage system comprising a power converter circuit that comprises a plurality of sub-batteries connected together in parallel, which are electrically isolated and connected to a DC link circuit of the power converter circuit, wherein the DC link circuit of the power converter circuit is electrically isolated, wherein each sub-battery is assigned a monitoring circuit comprising a differential current measuring sensor or circuit, an isolating circuit or switch and a controller circuit, wherein the controller circuit of the monitoring circuit is configured to switch the isolating circuit or switch and isolate a respective sub-battery associated therewith after a fault has been identified by the differential current measuring sensor or circuit by virtue of a differential current threshold value being exceeded, and further comprising a discharge capacitance to earth arranged as a feedback path for an earth current measurement of the differential current measuring sensor or circuit at at least one pole of the DC link circuit.
